(19) United States
(12) Patent Application Publication
(10) Pub. No.: US 2020/0347236 A1
(43) Pub. Date: Nov. 5, 2020

(54) FLEXIBLE HARDCOAT COMPRISING URETHANE OLIGOMER HYDROGEN BONDED TO AN ACRYLIC POLYMER SUITABLE FOR STRETCHABLE FILMS

(71) Applicant: 3M INNOVATIVE PROPERTIES COMPANY, St. Paul, MN (US)

(72) Inventors: Richard J. Pokorny, Maplewood, MN (US); Thomas P. Klun, Lakeland, MN (US); Chad M. Amb, Roberts, WI (US); Nicholas L. Untiedt, Minneapolis, MN (US); Matthew V.B. Topeff, Ham Lake, MN (US); Bruce A. Nerad, Oakdale, MN (US)

(21) Appl. No.: 16/764,891

(22) PCT Filed: Jan. 14, 2019
(86) PCT No.: PCT/IB2019/050279

§ 371 Date: May 18, 2020

Related U.S. Application Data
(60) Provisional application No. 62/621,268, filed on Jan. 24, 2018.

(51) Int. Cl. C09D 4/06; C08G 18/10; C08G 18/62; C08G 18/73; C08J 7/046; C08K 3/36; C09J 7/38; C08J 7/043

(52) U.S. Cl. CPC C09D 4/06; C08G 18/10; C08G 18/6233; C08G 18/73; C08K 2201/011; C08K 3/36; C09J 7/38; C08J 7/043; C08J 7/046

(57) ABSTRACT

A hardcoat composition is described comprising urethane (meth)acrylate oligomer having first functional groups; an acrylic polymer having second functional groups; wherein the first and second functional groups are capable of forming a hydrogen bond; and optionally nanoparticles. Also described are articles comprising the cured hardcoat described herein disposed on a surface of a substrate, method of using the articles, and methods of making the articles.

### BACKGROUND

WO2009/005975 describes flexible hardcoat compositions and protective films comprising the reaction product of one or more urethane (meth)acrylate oligomers; at least one monomer comprising at least three (meth)acrylate groups; and optionally inorganic nanoparticles.

Various graphic films have been described. See for example EP2604444; US2012/0197772; and US2014/0374000.

### SUMMARY

Although various hardcoat compositions have been described, industry would find advantage in hardcoat compositions suitable for stretchable (e.g. graphic) films having improved abrasion resistance and/or hot stretch properties.

In one embodiment, a hardcoat composition is described comprising an organic component comprising urethane (meth)acrylate oligomer having first functional groups; and acrylic polymer having second functional groups; wherein the first and second functional groups are capable of forming a hydrogen bond; and less than 30 wt.-% of inorganic oxide nanoparticles.

In other embodiments, articles are described comprising the cured hardcoat described herein disposed on a surface of a film substrate. A graphic may be disposed between the film substrate and cured hardcoat.

In another embodiment, a method of applying a film is described comprising providing a (e.g. graphic) film as described herein; stretching the film at least 50%; and

adhering the stretched film to a surface by means of the pressure sensitive adhesive.

Also described is a method of making an article comprising providing a substrate; providing the hardcoat composition as described herein on a surface of the substrate; and curing the hardcoat composition by exposure to actinic radiation.

### DETAILED DESCRIPTION OF THE PREFERRED EMBODIMENTS

Presently described are hardcoat compositions formed from the reaction product of a polymerizable composition comprising one or more urethane (meth)acrylate oligomer(s). Typically, the urethane (meth)acrylate oligomer is a di(meth)acrylate, a tri(meth)acrylate, tetra(meth)acrylate, or a combination thereof. The term “(meth)acrylate” is used to designate esters of acrylic and methacrylic acids.

The urethane (meth)acrylate oligomer contributes to the conformability and flexibility of the cured hardcoat composition. In preferred embodiments, a 13 micron thick film of the cured hardcoat composition is sufficiently flexible such that it can be bent around a 5, 4, 3, or 2 mm mandrel without cracking.

In some embodiments, the urethane (meth)acrylate oligomer is synthesized from reacting a polyisocyanate compound with a hydroxyl-functional acrylate compound.

A variety of polyisocyanates may be utilized in preparing the urethane (meth)acrylate oligomer. “Polyisocyanate” means any organic compound that has two or more reactive isocyanate (—NCO) groups in a single molecule such as diisocyanates, triisocyanates, tetraisocyanates, etc., and mixtures thereof. For improved weathering and diminished yellowing the, urethane (meth)acrylate oligomer(s) employed herein are preferably aliphatic and therefore derived from an aliphatic polyisocyanate. However, small concentrations of aromatic polyisocyanates can be usefully employed in combination with (e.g. linear aliphatic polyisocyanates, as described herein.

The urethane (meth)acrylate oligomer is typically the reaction product of hexamethylene diisocyanate (HDI), or derivatives thereof. In one embodiment, the urethane (meth)acrylate oligomer is the reaction product of hexamethylene-1,6-diisocyanate, such as “Desmodur™ H”. In another embodiment, the urethane (meth)acrylate oligomer is the reaction product of dicyclohexylmethane diisocyanate, such as “Desmodur™ W”. HDI derivatives include, but are not limited to, polyisocyanates containing biuret groups, such as the biuret adduct of hexamethylene diisocyanate (HDI) available from Covestro LLC under the trade designation “Desmodur N-100”, polyisocyanates containing isocyanurate groups, such as those available from Covestro under trade designation “Desmodur N-3300”, as well as polyisocyanates containing urethane groups, uretdione groups, carbodiimide groups, allophonate groups, and the like. Yet another useful derivative, is a hexamethylene diisocyanate (HDI) trimer, such as those available from Covestro under trade designation “Desmodur N-3800”.

In some embodiments, the urethane (meth)acrylate oligomer is the reaction product of a hexamethylene diisocyanate (HDI), optionally in combination with a HDI derivative, having an NCO content of at least 10, 15, 20, or 25 wt.-%. The NCO content is typically no greater than 50, 45, 40, or 35 wt.-%. The polyisocyanate typically has an equivalent weight of at least 50 or 75 and in some embodiments at least 100, or 125. The equivalent weight is typically no greater than 500, 450, or 400 and in some embodiments no greater than 350, 300, or 250 grams/per NCO group.

The hexamethylene diisocyanate (HDI) polyisocyanate is typically reacted with hydroxyl-functional acrylate compounds and optionally polyols.

The polyisocyanate is reacted with a hydroxyl-functional acrylate compound having the formula HOQ(A)p; wherein Q is a divalent organic linking group, A is a (meth)acryl functional group —XC(O)C(R₂)═CH₂ wherein X is O, S, or NR wherein R is H or C1-C4 alkyl, R₂ is a lower alkyl of 1 to 4 carbon atoms or H; and p is 1 to 6. The —OH group reacts with the isocyanate group forming a urethane linkage.

In some embodiments, the polyisocyanate can be reacted with a diol acrylate, such as a compound of the formula HOQ(A)Q₁Q(A)OH, wherein Q₁ is a divalent linking group and A is a (meth)acryl functional group as previously described. Representative compounds include hydantoin hexaacrylate (HHA) (e.g. Example 1 of U.S. Pat. No. 4,262,072 to Wendling et al.), and CH₂═C(CH₃)C(O)OCH₂CH(OH)CH₂O(CH₂)₄OCH₂CH(OH)CH₂OC(O)C(CH₃)═CH₂.

Q and Q₁ are independently a straight or branched chain or cycle-containing connecting group. Q can include a covalent bond, an alkylene, an arylene, an aralkylene, an alkarylene. Q can optionally include heteroatoms such as O, N, and S, and combinations thereof. Q can also optionally include a heteroatom-containing functional group such as carbonyl or sulfonyl, and combinations thereof.

In some embodiments, the hydroxyl-functional acrylate compounds used to prepare the urethane (meth)acrylate oligomer are monofunctional, such as in the case of hydroxyl ethyl acrylate, hydroxybutyl acrylate, caprolactone monoacrylate, available as SR495 from Sartomer, and mixtures thereof. In this embodiment, p=1.

In another embodiment, the hydroxyl-functional acrylate compounds used to prepare the urethane (meth)acrylate oligomer can be multifunctional, such as the in the case of glycerol dimethacrylate, 1-(acryloxy)-3-(methacryloxy)-2-propanol (CAS number 1709-71-3), pentaerythritol triacrylate. In this embodiment, p is at least 2, 4, 5, or 6. When hydroxyl-functional multi-acrylate compounds are utilized, the concentration of such is typically no greater than 10, 9, 8, 7, 6, 5, 4, 3, 2, or 1 wt.-% of the total hydroxy-functional acrylate compounds utilized to prepare the urethane (meth)acrylate oligomer.

In some embodiments, the polyisocyanate can be reacted with one or more hydroxyl-functional acrylate compounds and a polyol. In one embodiment, the polyol is an alkoxylated polyol available from Perstorp Holding AB, Sweden under the trade designation “Polyol 4800”. Such polyols can have a hydroxyl number of 500 to 1000 mg KOH/g and a molecular weight ranging from at least 200 or 250 g/mole up to about 500 g/mole. Such polyols are typically described as crosslinkers for polyurethanes.

In another embodiment, the polyol may be a linear or branched polyester diol derived from caprolactone. Polycaprolactone (PCL) homopolymer is a biodegradable polyester with a low melting point of about 60° C. and a glass transition temperature of about −60° C. PCL can be prepared by ring opening polymerization of epsilon-caprolactone using a catalyst such as stannous octanoate, as known in the art. One suitable linear polyester diols derived from caprolactone is Capa™ 2043, reported to have a hydroxyl number of 265-295 mg KOH/g and a mean molecular weight of 400 g/mole.

Notably, the hydroxyl-functional acrylate compound (HEA or SR495B), and (e.g. caprolactone) diol used in the preparation of the urethane (meth)acrylate oligomer are also aliphatic, lacking aromatic moieties. Thus, the urethane (meth)acrylate oligomer can contain little or no aromatic moieties. In some embodiments, the concentration of aromatic moieties is not greater than 10, 9, 8, 7, 6, 5, 4, 3, 2, or 1 wt.-%, based on the total weight of the urethane (meth)acrylate oligomer.

In other embodiments, the urethane (meth)acrylate oligomer may be obtained commercially; e.g., from Sartomer under the trade “CN 900 Series”, such as “CN981” and “CN981B88. Other suitable urethane (meth)acrylate oligomers are available from Sartomer Company under the trade designations “CN9001” and “CN991”. The physical properties of these aliphatic urethane (meth)acrylate oligomers, as reported by the supplier, are set forth as follows:

| | Viscosity | Tensile | | Tg (° C.) as |
|---|---|---|---|---|
| Trade | Cps at | Strength | | determined |
| Designation | 60° C. | psi | Elongation | by DSC |
| CN981 | 6190 | 1113 | 81 | 22 |
| CN981B88 | 1520 | 1520 | 41 | 28 |
| CN9001 | 46,500 | 3295 | 143 | 60 |
| CN991 | 660 | 5,378 | 79 | 27 |

The reported tensile strength, elongation, and glass transition temperature (Tg) properties are based on a homopolymer prepared from such urethane (meth)acrylate oligomer. These embodied urethane (meth)acrylate oligomers can be characterized as having an elongation of at least 20% and typically no greater than 200%; a Tg ranging from about 0 to 70° C.; and a tensile strength of at least 1,000 psi, or at least 5,000 psi.

In some embodiments, the urethane (meth)acrylate oligomer(s) has a calculated molecular weight ranging from 500 to 3,000 g/mole. The method for determining the calculated molecular weight of the urethane (meth)acrylate oligomer is described in the examples. In some embodiments, such as when passing the Hot Stretch Test at 150% is desired, the weight average molecular weight of the urethane (meth)acrylate oligomer is preferably at least 750 or 800 g/mole. However, passing the Hot Stretch Test at 125% together with improved abrasion resistance can be still be obtained when the urethane (meth)acrylate oligomer has a molecular weight less than 770 or 800 g/mole.

The hardcoat composition generally comprises the urethane (meth)acrylate oligomer(s) at a concentration ranging from at least 10 wt.-% to 60 wt.-% based on the wt.% solids of the organic component (e.g. excluding inorganic oxide nanoparticles and organic solvent when present). In some embodiments, the hardcoat composition comprises the urethane (meth)acrylate oligomer(s) at a concentration of at least 20, 25, 30, or 35 wt.-% based on the wt.-% solids of the organic component. The concentration of urethane (meth)acrylate oligomer can be adjusted based on the physical properties of the urethane (meth)acrylate oligomer selected. In some embodiments, such as when passing the Hot Stretch Test at 150% is desired, the hardcoat composition preferably comprises the urethane (meth)acrylate oligomer(s) at a concentration no greater than 55, 50, or 45 wt.-% based on the wt.-% solids of the organic component. However, passing the Hot Stretch Test at 125% together with improved abrasion resistance can still be obtained when the urethane (meth)acrylate oligomer concentration exceeds 50 wt.-% solids of the organic component.

The hardcoat composition comprises an acrylic copolymer. In some embodiments, the acrylic copolymer is derived from a major amount of methyl 2-methylprop-2-enote (also known as methyl methacrylate) and may be characterized as a poly(methyl methacrylate) (PMMA) copolymer. In other embodiments, the acrylic copolymer is derived from a major amount of another alkyl methacrylate, such as n-butyl (meth)acrylate.

In some embodiments, the acrylic copolymer generally comprises polymerized units of at least one (e.g. non-polar) high Tg monomer, i.e. a (meth)acrylate monomer when reacted to form a homopolymer has a Tg greater than 0° C. The high Tg monomer more typically has a Tg greater than 5° C., 10° C., 15° C., 20° C., 25° C., 30° C., 35° C., or 40° C.

In some embodiments, the acrylic copolymer comprises at least 50, 60, 70, 80, 90, 91, 92, 93, 94, 95, 96, 97, or 98 wt.-% of polymerized units of (e.g. non-polar) high Tg monomer(s).

The alkyl group of the high Tg monofunctional alkyl (meth)acrylate monomer is typically a straight chain, cyclic, or branched such as in the case of s-butyl methacrylate. When the acrylic copolymer comprises a high concentration of tertiary alkyl(meth)acrylate monomers such as t-butyl methacrylate, the abrasion resistance can be compromised.

Examples of high Tg monofunctional alkyl (meth)acrylate monomers include for example the previously described methyl methacrylate (Tg=105-115° C.) as well as ethyl methacrylate (Tg=65° C.), n-butyl methacrylate (Tg=20° C.), n-propyl methacrylate (Tg=37° C.), isobornyl acrylate (Tg=94° C.), isobornyl methacrylate (Tg=110° C.), and benzyl methacrylate (Tg=54° C.).

The acrylic copolymer optionally comprises polymerized units of at least one (e.g. non-polar) low Tg monomer, i.e. a (meth)acrylate monomer when reacted to form a homopolymer has a Tg of 0° C. or less. The low Tg monomer more typically has a Tg less than −5° C., −10° C., −15° C., −20° C., −25° C., −30° C., −35° C., −40° C., −45° C., −50° C. Examples of low Tg monofunctional alkyl (meth)acrylate monomers include for example n-butyl acrylate (Tg=−54° C.) and sec-butyl acrylate (Tg=−26° C.).

When the acrylic copolymer comprises polymerized units of (e.g. non-polar) low Tg monomer(s), the concetration of such is typically no greater than 10, 9, 8, 7, 6, 5, 4, 3, 2, or 1 wt.-% based on the total weight of the acrylic polymer.

The acrylic copolymer further comprises polymerized units of a comonomer that provides (e.g. second) functional groups that are capable of forming a hydrogen bond with the urethane (meth)acrylate oligomer. The bond between the first functional group of the urethane (meth)acrylate oligomer(s) and the second functional group of the acrylic polymer is a hydrogen bond. Hence, such functional groups do not form a covalent bond. Thus, the acrylic polymer does not covalently bond with the urethane (meth)acrylate oligomer during curing. Due to the lack of covalent bonding, the acrylic polymer can be solvent extracted from the cured coating composition.

A hydrogen bond is an attractive force, or bridge, occurring in polar compounds in which a hydrogen atom of one molecule or functional group is attracted to unshared electrons of another. The hydrogen atom is the positive end of one polar molecule or functional group (otherwise known as a hydrogen bond donor) and forms a linkage with the electronegative end of another molecule or functional group (otherwise known as a hydrogen bond acceptor). Hydrogen bonds generally occur between a donor hydrogen (H) atom covalently bound to a highly electronegative atom such as nitrogen (N), oxygen (O), or fluorine (F) and an acceptor, such as the free electrons on the carbonyl of a urethane group. Such a hydrogen atom is attracted to the electrostatic field of another highly electronegative atom nearby.

By definition, a urethane (meth)acrylate oligomer comprises organic units joined by carbamate (urethane) links, having the formula —NHC(O)O—. The carbonyl of the urethane linkage is capable of being a hydrogen bond acceptor. Thus, in typical embodiments, the acrylic copolymer further comprises polymerized units of a comonomer that provides (e.g. second) functional groups that are capable of donating a hydrogen bond to the (e.g. first) carbonyl acceptor of the carbamate linkages of the urethane (meth)acrylate oligomer. The urethane (meth)acrylate oligomer could comprise other substituents that are capable of forming a hydrogen bond.

The second functional groups of the acrylic polymer are typically hydroxyl groups including hydroxyl groups of acids. It is important to note that poly(meth)methacrylate, depicted as follows, is not capable of being a hydrogen bond donor.

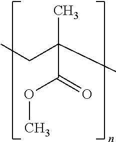

Although the hydroxyl group (—OH) is capable of being a hydrogen bond donor, the pendent methoxy group (—OCH₃) of PMMA is not capable of being a hydrogen bond donor.

Various comonomers may be used during the preparation of the acrylic copolymer to provide second functional groups. Such comonomers generally comprise an ethylenically unsaturated group and at least one hydroxyl group including hydroxyl groups of various acids such as sulfonic acids, phosphonic acids, and carbonic acids. The ethylenically unsaturated group of the comonomer copolymerizes with the (meth)acrylate group of the alkyl methacrylate forming the backbone of the acrylic copolymer. Representative comonomers are depicted as follows. Both the acrylate and/or (meth)acrylate of such comonomers can be employed.

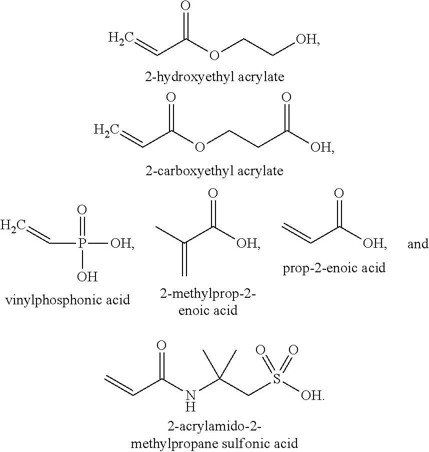

In some embodiments, at least 2, 3, 4, 5, 6, 7, 8, 9, or 10 wt.-% of the polymerized units of the acrylic copolymer comprises a second functional group capable of hydrogen bonding. The acrylic copolymer generally comprises the minimum amount of polymerized units comprising a second functional group capable of hydrogen bonding that provide the desired performance. In typical embodiments, the acrylic copolymer comprises no greater than 25, 20, or 15 wt.-% of polymerized units that comprises a second functional group capable of hydrogen bonding with the urethane (meth)acrylate oligomer.

In some embodiments, the acrylic polymer has an acid number, as determined according to ASTM D974-14 of zero. In other embodiments, the acrylic polymer has an acid number of at least 5, 10, 15, 20, or 25. The acrylic polymer typically has an acid number of no greater than 40, 45, or 50.

The acid number of the organic component can be determined by multiplying the acid number of the acrylic polymer by the weight fraction of acrylic polymer of the organic component. In some embodiments, the acid number of the hardcoat is zero based on the wt.-% solids of the organic component. In some embodiments, the acid number of the organic component is at least 5, 10, or 15. In some embodiments, the acid number of the organic component is no greater than 50, 40, 35, 30, 25, or 20.

In typical embodiments, the acrylic polymer has a hydroxyl number, as determined according to ASTM E222-10 of at least 5, 10, 15, 20, or 25. In some embodiments, acrylic polymer typically has a hydroxyl number of at least 30, 35, 40, 45, 50, 55, 60, 65, 70, or 75. In some embodiments, acrylic polymer typically has a hydroxyl number of no greater than 125 or 100.

The sum of the previously describe acid number and previously described hydroxyl number of the acrylic polymer can reflect the total number of hydrogen bonding cites of the acrylic polymer. In some embodiments, the sum ranges from 10 to 150.

The hydroxyl number of the organic component can be determined by multiplying the hydroxyl number of the acrylic polymer by the weight fraction of acrylic polymer of the organic components. In some embodiments, the hydroxyl number of the organic component is zero based on the wt.-% solids of the organic component. In some embodiments, the acid number of the organic component is at least 5, 10, or 15. In some embodiments, the hydroxyl number of the organic component is no greater than 70, 65, 60, 50, or 45.

The sum of the acid number of the organic component and the hydroxyl number of the organic component can reflect the total number of hydrogen bonding cites of the organic component. In some embodiments, the sum of the acid and hydroxyl numbers of the organic component is at least 15, 20, 25, 30, 35, or 40. In some embodiments, the sum of the acid and hydroxyl numbers of the organic component is no greater than 70, 65, 60, 50, or 45.

In some embodiments, the acrylic copolymer optionally comprises polymerized crosslinker units. In some embodiments, the crosslinker is a multifunctional crosslinker capable of crosslinking polymerized units of the (meth)acrylic polymer such as in the case of crosslinkers comprising functional groups selected from (meth)acrylate, vinyl, and alkenyl (e.g. C₃-C₂₀ olefin groups); as well as chlorinated triazine crosslinking compounds.

Examples of useful (e.g. aliphatic) multifunctional (meth)acrylate include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, and mixtures thereof.

Various combinations of two or more of crosslinkers may be employed.

When present, the crosslinker is typically present in an amount no greater than 2, 1, 0.5, or 0.1 wt.-% based on the total weight of the polymerized units of the acrylic copolymer.

The acrylic copolymer typically has a weight average molecular weight as determined with gel permeation chromatography and polystyrene standards of at least 5,000 g/mole. In some embodiments, such as when passing the Hot Stretch at 150% is desired, the acrylic copolymer preferably has a weight average molecular weight of at least 8,000 g/mole. The acrylic copolymer may have a weight average molecular weight of up to 100,000; 150,000; 200,000; 250,000, 300,000; 350,000; 400,000; 450,000 or 500,000 g/mole. However, passing the Hot Stretch Test at 125% together with improved abrasion resistance can still be obtained when the acrylic copolymer has a molecular weight less than 7700 or 8000 g/mole. Weight average molecular weights of the acrylic polymer can be measured, for example, by gel permeation chromatography (i.e., size exclusion chromatography (SEC)) using the test method described in greater detail in the examples.

The hardcoat composition generally comprises greater than 20 wt.-% and in some embodiments at least 25, 30, 35 or 40 wt.-% of acrylic copolymer based on the wt.-% solids of the organic component. In typical embodiments, the organic component of the hardcoat composition comprises up to about 85 wt.-% of the acrylic copolymer. In some embodiments, the amount of acrylic copolymer is no greater than 80 wt.-% s based on the wt.-% solids of the organic component. When the hardcoat composition comprises inorganic oxide nanoparticles, the preferred concentration of acrylic copolymer is typically less when the hardcoat composition comprises inorganic oxide nanoparticles. For example, the concentration of acrylic copolymer typically does not exceed about 50 wt.-% based on the wt.-% solids of the organic component.

The weight ratio of acrylic polymer to urethane (meth)acrylate oligomer typically ranges from 0.5:1 to 10:1. Higher concentrations of acrylic polymer can be preferred in order that the cured hardcoat composition passes the Hot Stretch Test at 125% or 150%. In some embodiments, the weight ratio of acrylic polymer to urethane (meth)acrylate oligomer is typically at least 0.6:1, 0.7:1, 0.8:1, 0.9:1, 1:1, 1.1:1 or 1.2:1. In some embodiments, the weight ratio of acrylic polymer to urethane (meth)acrylate oligomer is no greater than 9:1, 8:1, 7:1, 6:1, 5:1, 4:1, 3:1, or 2:1.

In some embodiments, the total amount of monofunctional (meth)acrylate monomers(s) in the hardcoat composition is less than 10, 9, 8, 7, 6, 5, 4, 3, 2, or 1 based on the wt.-% solids of the organic component. Inclusion of low concentrations of monofunctional (meth)acrylate monomers is amenable to passing the Hot Stretch Test at 150%.

In other embodiments, the hardcoat composition comprises 10 wt.-% or greater of high Tg monofunctional (meth)acrylate monomers, i.e. a homopolymer of the monofunctional (meth)acrylate monomer has a Tg of at least, 25, 30, 35, 40, 45, or 50° C. The Tg of the monofunctional (meth)acrylate monomer is typically no greater than 225° C. In some embodiments, the hardcoat composition comprises at least 15, 20, 25, 30, 35, or 40 wt.-% based on the wt.-% solids of the organic component. Higher concentration of high Tg monofunctional (meth)acrylate monomers can provide greater abrasion resistance (i.e. higher gloss values after abrasion). However, the preferred concentration can vary depending on the selection of urethane (meth)acrylate oligomer and acrylic copolymer.

The hardcoat composition described herein typically do not contain significant amounts of polymerized units derived from tri-, tetra-, or higher functional acrylates or methacrylates, or in other words multifunctional (meth)acrylate monomers. A “significant” amount of multifunctional (meth)acrylate monomers may be considered to be more than about 15 wt.-% solids of the hardcoat composition. In some embodiments, the total amount of multifunctional (meth)acrylate monomer(s) in the hardcoat composition is less than 10, 9, 8, 7, 6, 5, 4, 3, 2, or 1 wt.-% solids.

The hardcoat composition may optionally comprise surface modified inorganic oxide particles that add mechanical strength and durability to the resultant coating. The particles are typically substantially spherical in shape and relatively uniform in size. The particles can have a substantially monodisperse size distribution or a polymodal distribution obtained by blending two or more substantially monodisperse distributions. The inorganic oxide particles are typically non-aggregated (substantially discrete), as aggregation can result in precipitation of the inorganic oxide particles or gelation of the hardcoat.

The size of inorganic oxide particles is chosen to avoid significant visible light scattering. The hard coat composition generally comprises a significant amount of surface modified inorganic oxide nanoparticles having an average (e.g. unassociated) primary particle size or associated particle size of at least 20, 30, 40 or 50 nm and no greater than about 150 nm. The total concentration of inorganic oxide nanoparticles is typically less than 30 wt.-% solids of the total solids of the hardcoat. In some embodiments, the total concentration of inorganic oxide nanoparticles is less than 25, 20, 15, 10, 5, or 1 wt.-% solids of the total solids of the hardcoat.

In some embodiments, the hardcoat composition may optionally comprise up to about 10 wt.-% solids of smaller nanoparticles. Such inorganic oxide nanoparticles typically having an average (e.g. unassociated) primary particle size or associated particle size of at least 1 nm or 5 nm and no greater than 50, 40, or 30 nm.

The average particle size of the inorganic oxide particles can be measured using transmission electron microscopy to count the number of inorganic oxide particles of a given diameter. The inorganic oxide particles can consist essentially of or consist of a single oxide such as silica, or can comprise a combination of oxides, or a core of an oxide of one type (or a core of a material other than a metal oxide) on which is deposited an oxide of another type. Silica is a common inorganic particle utilized in hardcoat compositions. The inorganic oxide particles are often provided in the form of a sol containing a colloidal dispersion of inorganic oxide particles in liquid media. The sol can be prepared using a variety of techniques and in a variety of forms including hydrosols (where water serves as the liquid medium), organosols (where organic liquids so serve), and mixed sols (where the liquid medium contains both water and an organic liquid).

Aqueous colloidal silicas dispersions are commercially available from Nalco Chemical Co., Naperville, Ill. under the trade designation “Nalco Collodial Silicas” such as products 1040, 1042, 1050, 1060, 2327, 2329, and 2329K or Nissan Chemical America Corporation, Houston, Tex. under the trade name Snowtex™. Organic dispersions of colloidal silicas are commercially available from Nissan Chemical under the trade name Organosilicasol™. Suitable fumed silicas include for example, products commercially available from Evonik DeGussa Corp., (Parsippany, N.J.) under the trade designation, “Aerosil series OX-50”, as well as product numbers −130, −150, and −200. Fumed silicas are also commercially available from Cabot Corp., Tuscola, Ill., under the trade designations CAB-O-SPERSE 2095”, “CAB-O-SPERSE A105”, and “CAB-O-SIL M5”.

It may be desirable to employ a mixture of inorganic oxide particle types to optimize an optical property, material property, or to lower that total composition cost.

As an alternative to or in combination with silica the hardcoat may comprise various high refractive index inorganic nanoparticles. Such nanoparticles have a refractive index of at least 1.60, 1.65, 1.70, 1.75, 1.80, 1.85, 1.90, 1.95, 2.00 or higher. High refractive index inorganic nanoparticles include for example zirconia (“ZrO₂”), titania (“TiO₂”), antimony oxides, alumina, tin oxides, alone or in combination. Mixed metal oxide may also be employed.

Zirconia for use in the high refractive index layer are available from Nalco Chemical Co. under the trade designation “Nalco OOSSOO8”, Buhler AG Uzwil, Switzerland under the trade designation “Buhler zirconia Z-WO sol” and Nissan Chemical America Corporation under the trade name NanoUse ZR™. A nanoparticle dispersion that comprises a mixture of tin oxide and zirconia covered by antimony oxide (RI˜1.9) is commercially available from Nissan Chemical America Corporation under the trade designation “HX-05M5”. A tin oxide nanoparticle dispersion (RI˜2.0) is commercially available from Nissan Chemicals Corp. under the trade designation “CX-S401M”. Zirconia nanoparticles can also be prepared such as described in U.S. Pat. Nos. 7,241,437 and 6,376,590.

The inorganic nanoparticles of the hardcoat are preferably treated with a surface treatment agent. Surface-treating the nano-sized particles can provide a stable dispersion in the polymeric resin. Preferably, the surface-treatment stabilizes the nanoparticles so that the particles will be well dispersed in the polymerizable resin and results in a substantially homogeneous composition. Furthermore, the nanoparticles can be modified over at least a portion of their surface with a surface treatment agent so that the stabilized particle can copolymerize or react with the polymerizable resin during curing. The incorporation of surface modified inorganic particles is amenable to covalent bonding of the particles to the free-radically polymerizable organic components, thereby providing a tougher and more homogeneous polymer/particle network.

In general, a surface treatment agent has a first end that will attach to the particle surface (covalently, ionically or through strong physisorption) and a second end that imparts compatibility of the particle with the resin and/or reacts with resin during curing. Examples of surface treatment agents include alcohols, amines, carboxylic acids, sulfonic acids, phosphonic acids, silanes and titanates. The preferred type of treatment agent is determined, in part, by the chemical nature of the metal oxide surface. Silanes are preferred for silica and other for siliceous fillers. Silanes and carboxylic acids are preferred for metal oxides such as zirconia. The surface modification can be done either subsequent to mixing with the monomers or after mixing. It is preferred in the case of silanes to react the silanes with the particle or nanoparticle surface before incorporation into the resin. The required amount of surface modifier is dependent upon several factors such as particle size, particle type, modifier molecular weight, and modifier type. In general, it is preferred that approximately a monolayer of modifier is attached to the surface of the particle. The attachment procedure or reaction conditions required also depend on the surface modifier used. For silanes it is preferred to surface treat at elevated temperatures under acidic or basic conditions for from 1-24 hr approximately. Surface treatment agents such as carboxylic acids may not require elevated temperatures or extended time.

In some embodiments, inorganic nanoparticle comprises at least one copolymerizable silane surface treatment. Suitable (meth)acryl organosilanes include for example (meth)acryloy alkoxy silanes such as 3-(methacryloyloxy)propyltrimethoxysilane, 3-acryloylxypropyltrimethoxysilane, 3-(methacryloyloxy)propylmethyldimethoxysilane, 3-(acryloyloxypropyl)methyl dimethoxysilane, 3-(methacryloyloxy)propyldimethylmethoxysilane, and 3-(acryloyloxypropyl) dimethylmethoxysilane. In some embodiments, the (meth)acryl organosilanes can be favored over the acryl silanes. Suitable vinyl silanes include vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, and vinyltris(2-methoxyethoxy)silane.

The inorganic nanoparticle may further comprise various other surface treatments, as known in the art, such as a copolymerizable surface treatment comprising at least one non-volatile monocarboxylic acid having more than six carbon atom or a non-reactive surface treatment comprising a (e.g. polyether) water soluble tail.

To facilitate curing, polymerizable compositions described herein may further comprise at least one free-radical thermal initiator and/or photoinitiator. Typically, if such an initiator and/or photoinitiator are present, it comprises less than about 10 percent by weight, more typically less than about 5 percent of the polymerizable composition, based on the total weight of the polymerizable composition. Free-radical curing techniques are well known in the art and include, for example, thermal curing methods as well as radiation curing methods such as electron beam or ultraviolet radiation. Useful free-radical photoinitiators include, for example, those known as useful in the UV cure of acrylate polymers such as described in WO2006/102383.

The hardcoat composition may optionally comprise various additives. For example, silicone or fluorinated additive may be added to lower the surface energy of the hardcoat.

In one embodiment, the hardcoat coating composition further comprises at least 0.005 and preferably at least 0.01 wt-% solids of one or more perfluoropolyether urethane additives, such as described in U.S. Pat. No. 7,178,264. The total amount of perfluoropolyether urethane additives alone or in combination with other fluorinated additives typically ranges up to 0.5 or 1 wt.-% solids.

Certain silicone additives have also been found to provide ink repellency in combination with low lint attraction, as described in WO 2009/029438. Such silicone (meth)acrylate additives generally comprise a polydimethylsiloxane (PDMS) backbone and at least one alkoxy side chain terminating with a (meth)acrylate group. The alkoxy side chain may optionally comprise at least one hydroxyl substituent. Such silicone (meth)acrylate additives are commercially available from various suppliers such as Tego Chemie under the trade designations “TEGO Rad 2300”, “TEGO Rad 2250”, “TEGO Rad 2300”, “TEGO Rad 2500”, and “TEGO Rad 2700”. Of these, “TEGO Rad 2100” provided the lowest lint attraction.

The attraction of the hardcoat surface to lint can be further reduced by including an antistatic agent. For example, an antistatic coating can be applied to the (e.g. optionally primed) substrate prior to coating the hardcoat, such as described in WO2009/005975.

To enhance durability of the hardcoat layer, especially in outdoor environments exposed to sunlight, a variety of commercially available stabilizing chemicals can be added, such as described in previously cited WO2009/005975.

The polymerizable compositions can be formed by dissolving the free-radically polymerizable material(s) in a compatible organic solvent and then combining with the nanoparticle dispersion at a concentration of about 60 to 70 percent solids. A single organic solvent or a blend of solvents can be employed. Depending on the free-radically polymerizable materials employed, suitable solvents include alcohols such as isopropyl alcohol (IPA) or ethanol; ketones such as methyl ethyl ketone (MEK), methyl isobutyl ketone (MIBK), diisobutyl ketone (DIBK); cyclohexanone, or acetone; aromatic hydrocarbons such as toluene; isophorone; butyrolactone; N-methylpyrrolidone; tetrahydrofuran; esters such as lactates, acetates, including propylene glycol monomethyl ether acetate such as commercially available from 3M under the trade designation “3M Scotchcal Thinner CGS10” (“CGS10”), 2-butoxyethyl acetate such as commercially available from 3M under the trade designation “3M Scotchcal Thinner CGS50” (“CGS50”), diethylene glycol ethyl ether acetate (DE acetate), ethylene glycol butyl ether acetate (EB acetate), dipropylene glycol monomethyl ether acetate (DPMA), iso-alkyl esters such as isohexyl acetate, isoheptyl acetate, isooctyl acetate, isononyl acetate, isodecyl acetate, isododecyl acetate, isotridecyl acetate or other iso-alkyl esters; combinations of these and the like.

The method of forming the hardcoat article or hardcoat protective film includes providing a (e.g. light transmissible) substrate layer and providing the composition on the (optionally primed) substrate layer. The coating composition is dried to remove the solvent and then cured for example by exposure to ultraviolet radiation (e.g. using an H-bulb or other lamp) at a desired wavelength, preferably in an inert atmosphere (less than 50 parts per million oxygen) or an electron beam. Alternatively, a transferable hardcoat film may be formed coating the composition to a release liner, at least partially cured, and subsequently transferring from the release layer to the substrate using a thermal transfer or photoradiation application technique. In some embodiments, the flexible hardcoat described herein is thermoformable after curing.

The hardcoat composition can be applied as a single or multiple layers to a (e.g. display surface or film) substrate using conventional film application techniques. Thin films can be applied using a variety of techniques, including dip coating, forward and reverse roll coating, wire wound rod coating, and die coating. Die coaters include knife coaters, slot coaters, slide coaters, fluid bearing coaters, slide curtain coaters, drop die curtain coaters, and extrusion coaters among others. Many types of die coaters are described in the literature. Although it is usually convenient for the substrate to be in the form of a roll of continuous web, the coatings may be applied to sheets or individual parts.

The thickness of the cured hardcoat surface layer is typically at least 0.5 microns, 1 micron, or 2 microns. The thickness of the cured hardcoat layer is generally no greater than 50 microns or 25 microns. In some embodiments, the thickness is no greater than 20, 15, or 10 microns.

The cured hardcoat exhibits improved properties. As demonstrated by forthcoming Comparative Examples C-1 and C-2, in the absence of acrylic copolymer the urethane (meth)acrylate oligomer containing cured hardcoat fails the Hot Stretch Test at 100%. In the absence of urethane (meth)acrylate oligomer, the acrylic copolymer containing cured hardcoat also fails the Hot Stretch Test at 100%. As evidence by Comparative Example C-1, by combining a urethane (meth)acrylate oligomer with an acrylic copolymer that does not comprise second functional groups that are capable of forming a hydrogen bond with the first functional groups of the urethane (meth)acrylate oligomer (e.g. Elvacite 2021), the cured hardcoat improves, i.e. passes the Hot Stretch Test at 125% and high gloss after abrasion than Comparative Example C-1. However, as evidenced by the various examples, by combining a urethane (meth)acrylate oligomer with an acrylic copolymer that comprises second functional groups that are capable of forming a hydrogen bond with the first functional groups of the urethane (meth)acrylate oligomer, the cured hardcoat exhibits improved properties relative to Comparative Example C-3.

In some embodiments, the cured hardcoat has improved abrasion resistance relative to inclusion of an acrylic polymer that does not include hydrogen bonding functional groups (Comparative Example C-3). For example, a 6 micron thick coating of the cured hardcoat exhibits a gloss greater than 30 after abrasion testing according to the test method described in the forthcoming examples. The higher the gloss value, the better the abrasion resistance. In some embodiments, the gloss is at least 35, 40, 45, 50, or 55. The gloss is typically less than 75 or 70. When the hardcoat is utilized on flexible substrates, the cured hardcoat passes the Hot Stretch test at 125% or 150%.

In other embodiments, the cured hardcoat has improved Hot Stretch relative to inclusion of an acrylic polymer that does not include hydrogen bonding functional groups (Comparative Example C-3).

For example, a 6 micron thick coating of the cured hardcoat passes the Hot Stretch test at 150%. In this embodiment, the cured hardcoat may exhibit comparable gloss after abrasion testing as Comparative Example C-3, i.e. 25-30.

In preferred embodiments, the cured hardcoat exhibits both improved abrasion resistance and improved Hot Stretch properties.

Due to its optical clarity, the hardcoat described herein is particularly useful for application to light-transmissive film substrates or for use as a topcoat of a graphic film. The cured hardcoat and in some instances the film substrate have a transmission of at least 80%, at least 85%, and preferably at least 90%. The initial haze (i.e. prior to abrasion testing) of the substrate and cured hardcoat can be less than 1 or 0.5, or 0.4, or 0.2%.

In some embodiments, the cured hardcoat is disposed on a highly flexible film. The film may be characterized as a conformable film.

Suitable highly flexible and/or conformable films include, for example, polyvinyl chloride (PVC), plasticized polyvinyl chloride, polyurethane, polyethylene, polypropylene, fluoropolymer or the like or blends of such polymers with other (e.g. less flexible) polymers. In some embodiments, the film can be colored by inclusion of pigments and/or dyes.

In some embodiments, the highly flexible and/or conformable film can be characterized by tensile and elongation as described by 11.3 and 11.5 of ASTM D882-10 using a speed of 1 inch/min (i.e. 100% stain/min). In favored embodiments, the tensile strength is at least 10, 11, 12, 13, 14 or 15 MPa and typically no greater than 50, 45, 40, or 35 MPa. The elongation at break is at least 50, 100, 150, or 175% and may range up to 225, 250, 275, or 300%.

In some embodiments, the hardcoat also provides antireflective properties. For example, when the hardcoat comprises a sufficient amount of high refractive index nanoparticles, the hardcoat can be suitable as the high refractive index layer of an antireflective film. A low index surface layer is then applied to the high refractive index layer. Alternatively, a high and low index layer may be applied to the hardcoat such as described in U.S. Pat. No. 7,267,850.

For most applications, the substrate thickness is preferably less than about 0.5 mm, and more preferably about 20 microns to about 100, 150, or 200 microns. Self-supporting polymeric films are preferred. The polymeric material can be formed into a film using conventional filmmaking techniques such as by extrusion and optional uniaxial or biaxial orientation of the extruded film. The substrate can be treated to improve adhesion between the substrate and the adjacent layer, e.g., chemical treatment, corona treatment, plasma, flame, or actinic radiation. If desired, an optional tie layer or primer can be applied to the protective film or display substrate to increase the interlayer adhesion with the hardcoat.

In order to reduce or eliminate optical fringing it is preferred that the substrate has a refractive index close to that of the hardcoat layer, i.e. differs from the high refractive index layer by less than 0.05, and more preferably less than 0.02. When the substrate has a high refractive index, a high refractive index primer may be use such as a sulfopolyester antistatic primer, as described in U.S. Patent Application Publication No. 2008/0274352. Alternatively, optical fringing can be eliminated or reduced by providing a primer on the film substrate or illuminated display surface having a refractive index intermediate (i.e. median+/−0.02) between the substrate and the hardcoat layer. Optical fringing can also be eliminated or reduced by roughening the substrate to which the hardcoat is applied. For example the substrate surface may be roughened with a 9 micron to 30 micron microabrasive.

The cured hardcoat layer or film substrate to which the hardcoat is applied may have a gloss or matte surface. Matte films typically have lower transmission and higher haze values than typical gloss films. For example the haze is generally at least 5%, 6%, 7%, 8%, 9%, or 10% as measured according to ASTM D1003. Whereas gloss surfaces typically have a gloss of at least 130 as measured according to ASTM D 2457-03 at 60°; matte surfaces have a gloss of less than 120.

The hardcoat surface can be roughened or textured to provide a matte surface. This can be accomplished in a variety of ways as known in the art including embossing the hardcoat surface with a suitable tool that has been bead-blasted or otherwise roughened, as well as by curing the composition against a suitable roughened master as described in U.S. Pat. Nos. 5,175,030 (Lu et al.) and 5,183,597 (Lu).

Various permanent and removable grade adhesive compositions may be provided on the opposite side of the film substrate as the cured hardcoat. For embodiments that employ pressure sensitive adhesive, the graphic film article typically includes a removable release liner. During application to a display surface, the release liner is removed so the graphis film article can be adhered to a surface.

Suitable (e.g. pressure sensitive) adhesives include natural or synthetic rubber-based pressure sensitive adhesives, acrylic pressure sensitive adhesives, vinyl alkyl ether pressure sensitive adhesives, silicone pressure sensitive adhesives, polyester pressure sensitive adhesives, polyamide pressure sensitive adhesives, poly-alpha-olefins, polyurethane pressure sensitive adhesives, and styrenic block copolymer based pressure sensitive adhesives. Pressure sensitive adhesives generally have a storage modulus (E′) as can be measured by Dynamic Mechanical Analysis at room temperature (25° C.) of less than 3×10⁶ dynes/cm at a frequency of 1 Hz.

The pressure sensitive adhesives may be organic solvent-based, a water-based emulsion, hot melt (e.g. such as described in U.S. Pat. No. 6,294,249), heat activatable, as well as an actinic radiation (e.g. e-beam, ultraviolet) curable pressure sensitive adhesive. The heat activatable adhesives can be prepared from the same classes as previously described for the pressure sensitive adhesive. However, the components and concentrations thereof are selected such that the adhesive is heat activatable, rather than pressure sensitive, or a combination thereof.

The adhesive can be applied using a variety of known coating techniques such as transfer coating, knife coating, spin coating, die coating and the like.

In some embodiments, the adhesive layer is a repositionable adhesive layer. The term “repositionable” refers to the ability to be, at least initially, repeatedly adhered to and removed from a substrate without substantial loss of adhesion capability. A repositionable adhesive usually has a peel strength, at least initially, to the substrate surface lower than that for a conventional aggressively tacky PSA. Suitable repositionable adhesives include the adhesive types used on CONTROLTAC Plus Film brand and on SCOTCHLITE Plus Sheeting brand, both made by Minnesota Mining and Manufacturing Company, St. Paul, Minn., USA.

The adhesive layer may also be a structured adhesive layer or an adhesive layer having at least one microstructured surface. Upon application of film article comprising such a structured adhesive layer to a substrate surface, a network of channels or the like exists between the film article and the substrate surface. The presence of such channels or the like allows air to pass laterally through the adhesive layer and thus allows air to escape from beneath the film article and the surface substrate during application.

Topologically structured adhesives may also be used to provide a repositionable adhesive. For example, relatively large-scale embossing of an adhesive has been described to permanently reduce the pressure sensitive adhesive/substrate contact area and hence the bonding strength of the pressure sensitive adhesive. Various topologies include concave and convex V-grooves, diamonds, cups, hemispheres, cones, volcanoes and other three-dimensional shapes all having top surface areas significantly smaller than the base surface of the adhesive layer. In general, these topologies provide adhesive sheets, films and tapes with lower peel adhesion values in comparison with smooth surfaced adhesive layers. In many cases, the topologically structured surface adhesives also display a slow build in adhesion with increasing contact time.

An adhesive layer having a microstructured adhesive surface may comprise a uniform distribution of adhesive or composite adhesive “pegs” over the functional portion of an adhesive surface and protruding outwardly from the adhesive surface. A film article comprising such an adhesive layer provides a sheet material that is repositionable when it is laid on a substrate surface (See U.S. Pat. No. 5,296,277). Such an adhesive layer also requires a coincident microstructured release liner to protect the adhesive pegs during storage and processing. The formation of the microstructured adhesive surface can be also achieved for example by coating the adhesive onto a release liner having a corresponding micro-embossed pattern or compressing the adhesive, e.g. a PSA, against a release liner having a corresponding micro-embossed pattern as described in WO 98/29516.

In some favored embodiments, the article is a graphic film used to apply designs, e.g. images, graphics, text and/or information (such as a code), on windows, buildings, pavements or vehicles such as autos, vans, buses, trucks, streetcars and the like for e.g. advertising or decorative purposes. Such designs, images, text, etc. will collectively be referred to herein as a “graphic”. Many of the surfaces, e.g. vehicles, are irregular and/or uneven. In one embodiment, the graphic film is a decorative tape.

The graphic film typically comprises a dried and or cured ink layer. The dried ink layer can be derived from a wide variety of ink compositions including for example an organic solvent-based ink or water-based ink. The dried and cured ink layer can also be derived from a wide variety of radiation (e.g. ultraviolet) curable inks. The graphic (dried and cured ink layer) is typically disposed between the cured hardcoat composition and the (e.g. conformable polymeric film.

Colored inks typically comprise a colorant, such as a pigment and/or dye dispersed in a liquid carrier. The liquid carrier may comprise water, an organic monomer, a polymerizable reactive diluent in the case of radiation curable inks, or a combination thereof. For example, latex inks typically comprise water and (e.g. non-polymerizable) organic cosolvent.

Various methods may be used to provide a graphic on the film. Typical techniques include for example ink jet printing, thermal mass transfer, flexography, dye sublimation, screen printing, electrostatic printing, offset printing, gravure printing or other printing processes.

The graphic may be a single color or may be multi-colored. In the case of security markings, the graphic may be unapparent when viewed with wavelengths of the visible light spectrum. The graphic can be a continuous or discontinuous layer.

One example of a graphic film is 3M™ Wrap Film Series 1080 (G12 Gloss Black) available from 3M Company, St. Paul, Minn. The film is a dual cast vinyl film available in array of colors and finishes such as satin, matte, gloss, and brushed metal. Some of such films have a multi-color texture. The film has a structured adhesive layer with non-visible air release channels on the opposite surface as the hardcoat. Such films are utilized for solid color vehicle detailing, as well as commercial vehicle and fleet graphics.

The hardcoat described herein is especially useful for conformable (e.g. graphic) films that are stretched during using. One method of applying the conformable (e.g. graphic) film includes providing a film as described here further comprising a pressure sensitive adhesive on the opposing surface; stretching the film at least 50%; and adhering the stretched film to a surface by means of the pressure sensitive adhesive. In some embodiments, the films is stretched at least 75, 100, or 125%. In favored embodiments, the gloss of the film does not change by more than about 10% after stretching.

The various patents previously cited are incorporated herein by reference.

Objects and advantages of this invention are further illustrated by the following examples, but the particular materials and amounts thereof recited in these examples, as well as other conditions and details, should not be construed to unduly limit this invention.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

These abbreviations are used in the following examples: phr=parts per hundred rubber; g=grams, min=minutes, h=hour, ° C.=degrees Celsius, MPa=megapascals, and N-m=Newton-meter.

### Materials

| Material designation | Description |
|---|---|
| IRGACURE 184 | A photoinitiator, obtained from BASF, Wyandotte, MI, |
| | under trade designation “IRGACURE 184” |
| DBTDL | Dibutyltin diacrylate, obtained from Sigma-Aldrich |
| | Chemical Company, St. Louis, MO |
| SR495B | Caprolactone based acrylated mono-ol, of about 330-350 |
| | molecular weight from Sartomer, Exton, PA, under trade |
| | designation “SR495B”, Tg = −53° C. |
| Capa 2043 | Caprolactone diol of about 400 molecular weight from |
| | Perstorp, Warrington, Cheshire, UK under trade designation |
| | “CAPA 2043”. |
| Desmodur H (HDI) | Hexamethylene Diisocyanate, molecular weight 168, from |
| | Covestro LLC, Pittsburgh, PA under trade designation |
| | “DESMODUR H” equivalent weight 84, molecular weight |
| | 168 g/mole. |
| Desmodur W (H12MDI) | Hydrogenated methylene diisocyanate, from Covestro under |
| | designation “DESMODUR W”, equivalent weight 131, |
| | molecular weight 262 g/mole |
| MEK | Methyl ethyl ketone, obtained from Avantor Performance |
| | Materials, Center Valley, PA |
| ELVACITE 2021 | 119,000 MW PMMA resin, obtained from Lucite |
| | International, Cordova, TN, under trade designation |
| | “ELVACITE 2021” |
| Methyl Methacrylate | Obtained from Alfa Aesar, Ward Hill, MA |
| (MMA) | |
| 2,2′-azobis-(2- | Obtained from E.I. DuPont de Nemours and Company, |
| methylbutyronitrile) | Wilmington, DE, under trade designation “VAZO 67” |
| Ethyl acetate | Obtained from VWR International LLC, Radnor, PA |
| Toluene | Obtained from EMD Millipore Corporation, Billerica, MA |
| N,N-Dimethyl Acrylamide | Obtained from Alfa Aesar, Ward Hill MA |
| (DMA) | |
| Methacrylic Acid (MAA) | Obtained from Alfa Aesar, Ward Hill MA |
| 2-hydroxyethyl | Obtained from Evonik, Parsippany, NJ under the trade |
| methacrylate (HEMA) | designation “VISIOMER HEMA 98” |
| HEA | Hydroxy ethyl acrylate, obtained from Alfa Aesar, Ward |
| | Hill, MA |
| SR217 | Aliphatic monofunctional dimethyl cyclohexyl acrylate from |
| | Sartomer, Exton, PA, under trade designation “SR217” |
| SR513 | Cyclic trimethylolpropane formal acrylate from Sartomer, |
| | Exton, PA, under trade designation “SR531” |
| SR335 | lauryl acrylate from Sartomer, Exton, PA, under trade |
| | designation “SR335” |
| MEK-ST-L | 40-50 nm silica at 30% solids in MEK from Nissan |
| | Chemical America Corporation |
| | Houston, TX |

### Test Methods

### Method for Abrasion Test

Abrasion of the samples was tested cross web to the coating direction using a Taber model 5800 Heavy Duty Linear Abraser (obtained from Taber Industries, North Tonawanda, N.Y.). The stylus oscillated at 60 cycles/min. The stylus was a cylinder with a flat base and a diameter of 5 cm. The abrasive material used for this test was a general purpose scouring pad (obtained from 3M Company, St. Paul, Minn. under trade designation “SCOTCHBRITE #64660 DURABLE FLEX HAND PAD”).

3 cm squares were cut from the pads and adhered to the base of the stylus using permanent adhesive tape (obtained from 3M Company, St. Paul, Minn., under trade designation “3M SCOTCH PERMANENT ADHESIVE TRANSFER TAPE”). A single sample was tested for each example with a total weight of 0.5 kg weight and 10 cycles. After abrasion, the gloss at 60 degrees was measured for each sample using a BYK Micro-tri gloss meter (available from BYK Gardner, Columbia Md.) at three different points. Higher gloss values indicate better abrasion resistance.

### Molecular Weight Determination

The molecular weight distribution of the compounds was characterized using conventional gel permeation chromatography (GPC). The GPC instrumentation, which was obtained from Waters Corporation (Milford, Mass., USA), included a high pressure liquid chromatography pump (Model 1515HPLC), an auto-sampler (Model 717), a UV detector (Model 2487), and a refractive index detector (Model 2410). The chromatograph was equipped with two 5 micron PLgel MIXED-D columns, available from Varian Inc. (Palo Alto, Calif., USA). Samples of polymeric solutions were prepared by dissolving polymer or dried polymer materials in tetrahydrofuran at a concentration of 0.5 percent (weight/volume) and filtering through a 0.2 micron polytetrafluoroethylene filter that is available from VWR International (West Chester, Pa., USA). The resulting samples were injected into the GPC and eluted at a rate of 1 milliliter per minute through the columns maintained at 35° C. The system was calibrated with polystyrene or acrylic standards using a linear least squares fit analysis to establish a calibration curve. The weight average molecular weight (M_{w}) and the polydispersity index (weight average molecular weight divided by number average molecular weight) were calculated for each sample against this standard calibration curve.

### Method for Hot Stretch

Samples of the coated vinyl were cut into 3-1 cm×12 cm strips. These were applied to the panel at one end with the adhesive on the vinyl film. The center 5 cm was stretched to 10 cm and adhered to give a 100% stretched sample. The center 5 cm was stretched to 11.25 cm and adhered to give a 125% stretched sample. The center 5 cm was stretched to 12.5 cm and adhered to give a 150% stretched sample. The panel was then placed in a 100° C. oven for 10 min. The panels were then cooled and the samples visually inspected for cracks that indicate failure. The highest amount of stretch (e.g. 125% or 150%) in which the sample passed is reported.

### Preparation of Acrylic Copolymers

### Preparative Example A-1 (86:10.5:3.5 MMA:HEMA:MAA)

A 5 L, 3 necked, round bottom flask was equipped with a condenser, mechanical stirrer, and a thermometer and charged with methyl methacrylate (709.85 g), Visomer HEMA 98 (87.5 g), methacrylic acid (28.87 g), ethyl acetate (1933 g), and 2,2′-azobis-(2-methylbutyronitrile) (3.3 g). The solution was sparged with N₂ at a flow rate of 1 L/min for 30 min, then heated to 75° C. overnight (˜16 h) under an atmosphere of N₂. The solution was then diluted by the addition of ethyl acetate (1375 g) cooled to room temperature (RT) and sparged with air for ˜5 min. The resulting polymer was analyzed by GPC (conc. in vacuo, dissolved in THF and passed through a 0.2 μm PTFE filter) to give Mₙ=73600; M_{w}=138000; PDI=1.87 vs. acrylic standards.

### General Method for Preparative Examples A-2 to A-6

A 500 mL, 3 necked, round bottom flask was equipped with a condenser, mechanical stirrer and a thermometer and charged (amounts shown in table below) with methyl methacrylate, Visomer HEMA 98, ethyl acetate, and Vazo 67 (2,2′-azobis-(2-methylbutyronitrile). The solution was sparged with N2 at a flow rate of 1 L/min for 30 min, then heated to 75° C. overnight (˜16 h) under an atmosphere of N₂. The solution was then diluted by the addition of ethyl acetate (100 g) and cooled to room temperature (RT) and sparged with air for ˜5 min. The resulting polymer was analyzed by GPC (conc. in vacuo, dissolved in THF and passed through a 0.2 μm PTFE filter) vs. polystyrene standards.

| | MMA | HEMA | EtOAc | Vazo 67 | |
|---|---|---|---|---|---|
| | added | added | added | Added | Mw |
| Polymer | (g) | (g) | (g) | (g) | (PDI) |
| A-2 | 53.98 | 6.05 | 140.09 | 0.240 | 85600 (2.34) |
| A-3 | 52.45 | 7.54 | 139.04 | 0.241 | 84000 (2.36) |
| A-4 | 51.06 | 9.24 | 140.32 | 0.240 | 87400 (2.31) |
| A-5 | 49.61 | 10.51 | 140.67 | 0.240 | 82700 (2.33) |
| A-6 | 51.76 | 8.25 | 140.22 | 0.280 | 74300 (2.28) |

### Method for Preparative Examples A-7

A 4 oz amber glass bottle was charged with 13.5 g MMA, 1.5 g HEMA, and 35 g of a stock solution prepared from 843.18 g EtOAc and 1.45 g Vazo 67. The solution was sparged with N₂ at a flow rate of 3 L/min for 1 min, and sealed. The bottle was then heated to 60° C. in a launderometer for 24 hours. The solution was then diluted by the addition of ethyl acetate (25 g) and cooled to room temperature (RT). The bottle was mixed on a roller until a homogeneous solution was obtained. The resulting polymer was analyzed by GPC (conc. in vacuo, dissolved in THF and passed through a 0.2 PTFE filter) vs. polystyrene standards to give Mₙ=68,300; M_{w}=189,300, PDI 2.76.

### Method for Preparative Examples A-8

A 4 oz amber glass bottle was charged with 13.5 g MMA, 0.9 g HEMA, 0.6 g MAA, and 35 g of a stock solution prepared from 843.18 g EtOAc and 1.45 g Vazo 67. The solution was sparged with N₂ at a flow rate of 3 L/min for 1 min, and sealed. The bottle was then heated to 60° C. in a launderometer for 24 hours. The solution was then diluted by the addition of ethyl acetate (25 g) and cooled to room temperature (RT). The bottle was mixed on a roller until a homogeneous solution was obtained. The resulting polymer was analyzed by GPC (conc. in vacuo, dissolved in THF and passed through a 0.2 μm PTFE filter) vs. polystyrene standards to give Mₙ=66,100; M_{w}=175,600, PDI 2.67.

### Solvent Stock Solution for A-9 to A-11

A 16 oz glass amber bottle was charged with 324.29 g EtOAc and 0.56 g Vazo 67. The bottle was swirled until the Vazo 67 was dissolved.

### Monomer Stock Solution for A-9 to A-11

A 16 oz glass amber bottle was charged with 162.8 g MMA, 16.65 g HEMA, and 5.55 g MAA. The bottle was swirled to ensure mixing.

### General Method for Polymers A-9 to A-11

A 4 oz amber glass bottle was charged with the above solvent stock solution, monomer stock solution, and isooctyl thioglycolate (IOTG) (amounts in table below). The solution was sparged with N₂ at a flow rate of 3 L/min for 1 min, and sealed. The bottle was then heated to 75° C. in a launderometer for 24 hours. The solution was then diluted by the addition of ethyl acetate (amounts below) and cooled to room temperature (RT). The bottle was mixed on a roller until a homogeneous solution was obtained. The resulting polymer was analyzed by GPC (conc. in vacuo, dissolved in THF and passed through a 0.2 μm PTFE filter) vs. polystyrene standards.

| | Solvent | Monomer | | Post- | |
|---|---|---|---|---|---|
| | Stock | Stock | | reaction | |
| | Solution | Solution | IOTG | EtOAc | |
| | added | added | added | added | Mw |
| Polymer | (g) | (g) | (g) | (g) | (PDI) |
| A-9 | 35 | 15 | 0 | 25.0 | 75,900 (2.79) |
| A-10 | 36.2 | 15 | 0.51 | 25.9 | 13,000 (2.04) |
| A-11 | 37.4 | 15 | 1.02 | 26.7 | 7,600 (1.93) |

### Monomer Stock Solution for A-12

A 32 oz amber glass jar was charged with 247.69 g MMA, 30.28 g HEMA, and 10.11 g DMA. The jar was swirled until mixing occurred.

### Method for Polymer A-12

A 32 oz amber glass jar was charged with 90.0 g monomer stock solution, 168.4 g ethyl acetate, and 0.363 g Vazo 67. The solution was sparged with N₂ at a flow rate of 1 L/min for 5 min, and sealed. The bottle was then heated to 75° C. in a launderometer for 24 hours. The solution was then diluted by the addition of ethyl acetate (192 g) and cooled to room temperature (RT). The bottle was mixed on a roller until a homogeneous solution was obtained. The resulting polymer was analyzed by GPC (conc. in vacuo, dissolved in THF and passed through a 0.2 μm PTFE filter) vs. acrylic standards to give Mₙ=94,800, M_{w}=215,700, PDI=2.27.

### Preparation of Urethane Acrylate Oligomer

### Preparative Example PE-1

A 1000 mL jar equipped with stir bar was charged with 57.99 g (0.29 eq) Capa 2043, 123.5 g (0.3586 eq) SR495B, 41.64 g (0.3586 eq) HEA, then 116.67 g MEK, 126.86 g (0.9666 eq) H12MDI, and finally 0.175 g (500 ppm based on solids) DBTDL. This reaction is 75% solids, 25% solvent. The jar was shaken, then placed in a room temperature water bath for 25 min. The jar was then placed in a 60° C. bath. After reaction for about 18 h, an FTIR was taken of an aliquot of the reaction and found to have a minimal —NCO peak at 2265 cm⁻¹.

The Preparative Examples PE-1 through PE-6, PE-8 were all run similarly at 75% solids with 500 ppm DBTDL with respect to solids.

The Preparative Examples PE-7, and PE-9 though PE-10 were run in a slightly different way. The diisocyanate, the Capa2043 diol, MEK and DBTDL were reacted for about 10 min in a water bath, then about 2 h in a 60° C. bath. The mono-ol SR495B was then added in one portion, and the reaction was continued for about 18 h at 60° C. An FTIR was taken of an aliquot of the reaction and found to have a minimal —NCO peak at 2265 cm⁻¹.

The solids in grams for Examples PE-1 to PE-10 are depicted in Table 2.

The equivalent ratios shown in Table 1, were calculated by setting the number of equivalents of isocyanate (0.9666 eq) to 10 and then normalizing the number of equivalents of alcohols to that value. Thus the equivalent ratio of Capa 2043 is (0.29/0.9666)*10 or 3.0; the equivalent ratio of SR495B is (0.3586/0.9666)*10 or 3.71; and the equivalent ratio of HEA is (0.3586/0.9666)*10 or 3.71. Empirically it was found, that when 3.0 equivalents of Capa 2043 is used as it was in this example, that an excess of SR495B and HEA of 6% each, or 3.5*1.06 or 3.71 equivalents was needed to consume all of the isocyanate groups. Thus, the equivalent rations of SR495B and HEA were reported as 3.5 (3.71/1.06). The approximate equivalent ratios of the components of the urethane acrylate oligomers, were calculated as described above, and are reported in Table 1 below.

The calculated molecular weight of the urethane acrylate oligomer was arrived at in the following way, illustrated with PE-1. The equivalents of monols used are normalized to 2.

| Preparative- | | | Capa | | |
|---|---|---|---|---|---|
| example | H12MDI | HDI | 2043 | SR495B | HEA |
| PE-1 (normalized | 10 | | 3 | 3.5 | 3.5 |
| to 10 eq isocyanate) | | | | | |
| PE-2 (normalized | 2.857 | | 0.857 | 1.0 | 1.0 |
| to 2 eq of monols) | | | | | |

Next these ratios are multiplied by the EW of the corresponding component and summed.
For PE-1 the calculation is:

2.857*131.25+0.875*200+1*344+1*116.12=1006.9 or 1007.

TABLE 1
Approximate Equivalent Ratios and Calculated Molecular Weight of Polyurethane Acrylates

| | | | | | | PUA |
|---|---|---|---|---|---|---|
| | | | | | | Calculated |
| Preparative- | | | Capa | | | Molecular |
| example | H12MDI | HDI | 2043 | SR495B | HEA | Weight |
| PE-1 | 10 | | 3 | 3.5 | 3.5 | 1007 |
| PE-2 | 10 | | 5 | 2.5 | 2.5 | 1384 |
| PE-3 | 10 | | 4 | 2.67 | 3.33 | 1139 |
| PE-4 | 10 | | | 6.67 | 3.33 | 797 |
| PE-5 | 10 | | | 10 | | 950 |
| PE-6 | | 10 | | 10 | | 856 |
| PE-7 | | 10 | 5 | 5 | | 1424 |
| PE-8 | 10 | | | 5 | 5 | 722 |
| PE-9 | | 10 | 6.25 | 3.75 | | 1800 |
| PE-10 | | 10 | 7.5 | 2.5 | | 2560 |

TABLE 2
Solids in grams for Preparative Examples

| Preparative- | | | Capa | | |
|---|---|---|---|---|---|
| example | H12MDI | HDI | 2043 | SR495B | HEA |
| PE-1 | 126.86 | | 57.99 | 123.5 | 41.64 |
| PE-2 | 9.35 | | 7.12 | 6.38 | 2.15 |
| PE-3 | 9.45 | | 5.76 | 6.89 | 2.90 |
| PE-4 | 16.42 | | | 28.75 | 4.84 |
| PE-5 | 13.8 | | | 36.2 | |
| PE-6 | | 9.36 | | 40.64 | |
| PE-7 | | 11.47 | 13.64 | 24.89 | |
| PE-8 | 18.15 | | | 25.01 | 8.43 |
| PE-9 | | 12.07 | 18.97 | 18.97 | |
| PE-10 | | 12.71 | 23.97 | 13.32 | |

### Examples 1-35 (EX1-EX35) and Comparative Examples C1-C3

EX1 coating solution was prepared by mixing the components as summarized in Table 3, below. Desired amount of the PUA solution was added to desired amount of acrylic copolymer solution and monomer with stirring. The other components summarized in Table 2, below were added. If required, heat was applied to produce a clear, compatible solution. Note that the amounts of various components added to prepare the coating solutions were in wt.-% solids. MEK was added to get to prepare a 20% solids solution.

Then, to prepare the EX1 sample, the above prepared EX1 coating solution was coated at 20 wt.-% solids on 3M™ Wrap Film Series 1080 (G12 Gloss Black) obtained from 3M Company, St. Paul, Minn. The coating was done using a #22 wire wound rod (available from R.D. Specialties, Webster N.Y.) and dried at 60° C. for 2 minutes. The coating was then cured using a Fusion H bulb (available from Fusion UV Systems, Gaithersburg Md.) at 100% power under nitrogen at 50 feet/minute (15.2 m/min). The cured coating had a thickness of about 6 microns. EX2-EX35, and C-1 to C-3 were prepared in the same manner as EX1 except that the compositions of the corresponding coating solutions were varied as described in Table 2, below.

The dried and cured hard coated PVC film samples were tested using the test methods described above. The data is summarized in Table 2, below.

TABLE 3
Compositions and Results

| | | | | Gloss | |
|---|---|---|---|---|---|
| | PUA | Acrylic | SR217 g | After | Hot |
| EX. | g | Polymer/g | (Irg 184 g) | Abrasion | Stretch |
| C-1 | PE-1 | A-1/93.62 | 5.55 | 19 | <100, |
| | 0.00 | | (0.83) | | Failed |
| | | | | | 100% |
| C-2 | PE-1 | A-1/0.00 | 5.55 | 76 | <100, |
| | 93.62 | | (0.83) | | Failed |
| | | | | | 100% |
| C-3 | PE-1 | Elvacite | 5.54 | 28 | 125, |
| | 34.79 | 2021/58.84 | (0.83) | | Failed |
| | | | | | 150% |
| 1 | PE-1 | A-1/58.84 | 5.54 | 32 | 150 |
| | 34.79 | | (0.83) | | |
| 2 | PE-1 | A-1/76.42 | 5.56 | 25 | 150 |
| | 17.19 | | (0.83) | | |
| 3 | PE-10 | A-1/69.92 | 7.60 | 35 | 150 |
| | 21.38 | | (1.10) | | |
| 4 | PE-9 | A-1/69.92 | 7.60 | 27 | 150 |
| | 21.38 | | (1.10) | | |
| 5 | PE-7 | A-1/73.86 | 6.07 | 35 | 150 |
| | 19.16 | | (0.91) | | |
| 6 | PE-2 | A-1/73.86 | 6.07 | 25 | 150 |
| | 19.16 | | (0.91) | | |
| 7 | PE-3 | A-1/73.86 | 6.07 | 28 | 150 |
| | 19.16 | | (0.91) | | |
| 8 | PE-1 | A-1/73.86 | 6.07 | 26 | 150 |
| | 19.16 | | (0.91) | | |
| 9 | PE-5 | A-1/73.86 | 6.07 | 28 | 150 |
| | 19.16 | | (0.91) | | |
| 10 | PE-6 | A-1/73.86 | 6.07 | 27 | 150 |
| | 19.16 | | (0.91) | | |
| 11 | PE-4 | A-1/73.86 | 6.07 | 35 | 150 |
| | 19.16 | | (0.91) | | |
| 12 | PE-7 | A-1/58.77 | 5.80 | 44 | 150 |
| | 34.60 | | (0.83) | | |
| 13 | PE-7 | A-1/54.70 | 12.32 | 44 | 150 |
| | 32.21 | | (0.77) | | |
| 14 | PE-7 | A-1/50.22 | 19.50 | 53 | 150 |
| | 29.57 | | (0.71) | | |
| 15 | PE-7 | A-1/45.38 | 27.27 | 42 | 150 |
| | 26.72 | | (0.64) | | |
| 16 | PE-7 | A-1/51.33 | 17.50 | 42 | 150 |
| | 30.45 | | (0.72) | | |
| 17 | PE-7 | A-1/51.33 | 17.50 | 44 | 150 |
| | 30.45 | | (0.72) | | |
| 18 | PE-7 | A-1/44.09 | 29.14 | 37 | 150 |
| | 26.15 | | (0.62) | | |
| 19 | PE-7 | A-7/55.16 | 6.01 | 57 | 150 |
| | 38.04 | | (0.80) | | |
| 20 | PE-7 | A-8/55.16 | 6.01 | 41 | 150 |
| | 38.04 | | (0.80) | | |
| 21 | PE-7 | A-9/55.16 | 6.01 | 51 | 150 |
| | 38.04 | | (0.80) | | |
| 22 | PE-7 | A-10/55.16 | 6.01 | 48 | 150 |
| | 38.04 | | (0.80) | | |
| 23 | PE-7 | A-12/55.16 | 6.01 | 42 | 150 |
| | 38.04 | | (0.80) | | |
| 24 | PE-7 | A-2/55.16 | 6.01 | 45 | 150 |
| | 38.04 | | (0.80) | | |
| 25 | PE-7 | A-3/55.16 | 6.01 | 42 | 150 |
| | 38.04 | | (0.80) | | |
| 26 | PE-7 | A-4/55.16 | 6.01 | 43 | 150 |
| | 38.04 | | (0.80) | | |
| 27 | PE-7 | A-5/55.16 | 6.01 | 41 | 150 |
| | 38.04 | | (0.80) | | |
| 28 | PE | A-6/55.16 | 6.01 | 43 | 150 |
| | 38.04 | | (0.80) | | |
| 29 | PE-7 | A-1/61.98 | 5.09 | 36 | 150 |
| | 32.16 | | (0.76) | | |
| 30 | PE-7 | A-1/53.40 | 4.39 | 49 | 150 |
| | 41.56 | | (0.66) | | |
| 31 | PE-1 | A-1/41.61 | 5.55 | 42 | 100 |
| | 52.01 | | (0.83) | | |
| 32 | PE-8 | A-1/69.92 | 7.60 | 32 | <100, |
| | 21.38 | | (1.10) | | Failed |
| | | | | | 100% |
| 33 | PE-7 | A-1/62.39 | 0.00 | 44 | 125, |
| | 36.73 | | (0.88) | | Failed |
| | | | | | 150% |
| 34 | PE-7 | A-1/40.47 | 34.95 | 31 | 100, |
| | 24.01 | | (0.57) | | Failed |
| | | | | | 125% |
| 35 | PE-7 | A-11/55.16 | 6.01 | 32 | 125, |
| | 38.04 | | (0.80) | | Failed |
| | | | | | 150% |
| 36 | PE-1 | A-1/73.86 | SR 335-6.07 | 29 | 150 |
| | 19.16 | | (0.91) | | |
| 37 | PE-1 | A-1/73.86 | SR 531-6.07 | 28 | 150 |
| | 19.16 | | (0.91) | | |
| 38 | PE-1 | A-1/73.86 | SR 217-6.07 | 22 | 150 |
| | 19.16 | MEK-STL- | (0.91) | | |
| | | 10 phr | | | |

| | | | |
|---|---|---|---|
| C4 | Example 10 of WO 2009/005975- | 45 | <100 |
| | 6 micron thickness | | |

TABLE 4
Hydroxyl Number, Acid Number, and
Acrylic Polymer: PUA Weight Ratio

| | | | | Total Formulation | | |
|---|---|---|---|---|---|---|
| | Acrylic Polymer | | | | | Acrylic |
| | | OH | Acid | | | Polymer: |
| | | Number | Number | | | PUA |
| | Acrylic | (ASTM | (ASTM | OH | Acid | Weight |
| | Polymer | E222-10) | D974-14) | Number | Number | Ratio |
| 1 | A-1 | 45.3 | 22.8 | 26.6 | 13.4 | 1.69:1 |
| 2 | A-1 | 45.3 | 22.8 | 34.6 | 17.4 | 4.45:1 |
| 3 | A-1 | 45.3 | 22.8 | 31.6 | 16.0 | 3.27:1 |
| 4 | A-1 | 45.3 | 22.8 | 31.6 | 16.0 | 3.27:1 |
| 5 | A-1 | 45.3 | 22.8 | 33.4 | 16.9 | 3.85:1 |
| 6 | A-1 | 45.3 | 22.8 | 33.4 | 16.9 | 3.85:1 |
| 7 | A-1 | 45.3 | 22.8 | 33.4 | 16.9 | 3.85:1 |
| 8 | A-1 | 45.3 | 22.8 | 33.4 | 16.9 | 3.85:1 |
| 9 | A-1 | 45.3 | 22.8 | 33.4 | 16.9 | 3.85:1 |
| 10 | A-1 | 45.3 | 22.8 | 33.4 | 16.9 | 3.85:1 |
| 11 | A-1 | 45.3 | 22.8 | 33.4 | 16.9 | 3.85:1 |
| 12 | A-1 | 45.3 | 22.8 | 26.6 | 13.4 | 1.70:1 |
| 13 | A-1 | 45.3 | 22.8 | 24.8 | 12.5 | 1.70:1 |
| 14 | A-1 | 45.3 | 22.8 | 22.7 | 11.5 | 1.70:1 |
| 15 | A-1 | 45.3 | 22.8 | 20.5 | 10.4 | 1.70:1 |
| 16 | A-1 | 45.3 | 22.8 | 23.2 | 11.7 | 1.70:1 |
| 17 | A-1 | 45.3 | 22.8 | 23.2 | 11.7 | 1.70:1 |
| 18 | A-1 | 45.3 | 22.8 | 20.0 | 10.1 | 1.70:1 |
| 19 | A-7 | 43.1 | 0.0 | 23.8 | 0.0 | 1.45:1 |
| 20 | A-8 | 25.9 | 26.1 | 14.3 | 14.4 | 1.45:1 |
| 21 | A-9 | 38.8 | 19.6 | 21.4 | 10.8 | 1.45:1 |
| 22 | A-10 | 37.5 | 18.9 | 20.7 | 10.4 | 1.45:1 |
| 23 | A-12 | 45.3 | 0.0 | 25.0 | 0.0 | 1.45:1 |
| 24 | A-2 | 43.1 | 0.0 | 23.8 | 0.0 | 1.45:1 |
| 25 | A-3 | 53.9 | 0.0 | 29.7 | 0.0 | 1.45:1 |
| 26 | A-4 | 66.0 | 0.0 | 36.4 | 0.0 | 1.45:1 |
| 27 | A-5 | 75.0 | 0.0 | 41.4 | 0.0 | 1.45:1 |
| 28 | A-6 | 59.1 | 0.0 | 32.6 | 0.0 | 1.45:1 |
| 29 | A-1 | 45.3 | 22.8 | 28.1 | 14.1 | 1.93:1 |
| 30 | A-1 | 45.3 | 22.8 | 24.2 | 12.2 | 1.28:1 |
| 31 | A-1 | 45.3 | 22.8 | 18.8 | 9.5 | 0.8:1 |
| 32 | A-1 | 45.3 | 22.8 | 31.6 | 16.0 | 3.27:1 |
| 33 | A-1 | 45.3 | 22.8 | 28.2 | 14.2 | 1.89:1 |
| 34 | A-1 | 45.3 | 22.8 | 18.3 | 9.2 | 1.69:1 |
| 35 | A-11 | 36.2 | 18.3 | 20.0 | 10.1 | 1.45:1 |
| 36 | A-1 | 45.3 | 22.8 | 33.4 | 16.9 | 3.85:1 |
| 37 | A-1 | 45.3 | 22.8 | 33.4 | 16.9 | 3.85:1 |
| 38 | A-1 | 45.3 | 22.8 | 30.1 | 15.2 | 3.85:1 |

1. A hardcoat composition comprising:
an organic component comprising
urethane (meth)acrylate oligomer having first functional groups;
an acrylic polymer having second functional groups;
wherein the first and second functional groups are capable of forming a hydrogen bond; and
0 to 30 wt.-% inorganic oxide nanoparticles.

2. The hardcoat composition of claim 1 further comprising monofunctional ethylenically unsaturated monomer.

3. The hardcoat composition of claim 2 wherein a homopolymer of the monofunctional ethylenically unsaturated monomer has a glass transition temperature greater than 25° C.

4. The hardcoat composition of claim 2 wherein the hardcoat composition comprises no greater than 35 or 30 wt.-% of monofunctional ethylenically unsaturated monomer based on the wt.-% solids of the organic component.

5. The hardcoat composition of claim 1 wherein the acrylic polymer has a weight average molecular weight ranging from 5,000 to 300,000 g/mole as determined with gel permeation chromatography and polystyrene standards.

6. (canceled)

7. The hardcoat composition of claim 1 wherein the urethane (meth)acrylate oligomer has a calculated molecular weight ranging from 500 to 3,000 g/mole.

8. (canceled)

9. The hardcoat composition of claim 1 wherein the urethane (meth)acrylate oligomer is present in an amount ranging from 10 to 60 wt.-% based on the wt.-% solids of the organic component.

10. (canceled)

11. The hardcoat composition of claim 1 wherein the acrylic polymer and urethane (meth)acrylate oligomer and are present at a weight ratio ranging from 0.5:1 to 10:1.

12. The hardcoat composition of claim 1 wherein the first functional groups of the urethane (meth)acrylate oligomer comprise a urethane group and the second functional groups of the acrylic polymer comprise acid groups, hydroxyl groups, or a combination thereof.

13. The hardcoat composition of claim 1 wherein the acrylic polymer does not covalently bond with the urethane (meth)acrylate oligomer during curing such that the acrylic polymer can be solvent extracted from the cured coating composition.

14. The hardcoat composition of claim 1 wherein the urethane (meth)acrylate oligomer is the reaction product of a polyisocyanate, a hydroxyl-functional acrylate compound, and optionally a polyol.

15. The hardcoat composition of claim 14 wherein the polyol is a caprolactone diol.

16. (canceled)

17. (canceled)

18. (canceled)

19. The hardcoat composition of claim 1 further comprising organic solvent.

20. The hardcoat composition of claim 1 wherein a 6 micron film of the cured hardcoat passes the Hot Stretch Test at 150%.

21. (canceled)

22. The hardcoat composition of claim 1 wherein the cured hardcoat is light transmissive.

23. An article comprising the cured hardcoat composition of claim 1 disposed on a surface of a substrate.

24. The article of claim 23 wherein the substrate is a polymeric film having an elongation of at least 175% when determined as described in 11.3 and 11.5 of ASTM D882-10 using a speed of 1 inch/min (i.e. 100% stain/min).

25. The article of claim 23 further comprising a pressure sensitive adhesive disposed on the opposing surface of the polymeric film.

26. The article of claim 23 wherein the polymeric film is colored.

27. A method of applying a film comprising:
providing a film according to claim 25;
stretching the film at least 50%; and
adhering the stretched film to a surface by means of the pressure sensitive adhesive.

28. (canceled)
